(19) United States
(12) Patent Application Publication
(10) Pub. No.: US 2006/0153672 A1
(43) Pub. Date: Jul. 13, 2006

(54) Furling wind turbine

(76) Inventor: Dean A. Davis, Spanish Fork, UT (US)

Correspondence Address: Angus C. Fox, III, 4093 N. Imperial Way, Provo, UT, 84604-5386, US

(21) Appl. No.: 10/832,747

(22) Filed: Apr. 26, 2004

Related U.S. Application Data
(60) Provisional application No. 60/465,349, filed on Apr. 24, 2003.

(51) Int. Cl. F03D 7/06

(52) U.S. Cl. 415/4.2

(57) ABSTRACT

A stall control wind turbine is eguipped with a latchable furling mechanism so that, except in the event of a fault condition or dangerously high winds, the rotor faces directly into the prevailing wind while generating power. A fault condition may occur when the electrical power grid, to which the wind turbine is connected, fails, when the alternator armature winding develops an open circuit and causes an unloading of the turbine, or when the gearbox breaks, also causing an unloading of the turbine. For a preferred embodiment of the invention, the release mechanism employs an electromagnet, which when energized, maintains the tail boom locked in place and the tail in the proper position to maintain the aerodynamic force. The wind turbine may also be eguipped with an electrically released mechanical brake and a back-up centrifugal brake.

This application has a priority date based on Provisional Patent Application No. 60/465,349, which was filed on Apr. 24, 2003.

### BACKGROUND OF THE INVENTION

1. Field of the Invention

This invention generally relates to furling wind turbines and, more particularly, to a wind turbine having latched furling.

2. Description of the Prior Art

Many small prior-art variable-speed wind turbines have a pivoting, or furling, tail to reduce the power output and structural loading during periods of high wind speed. FIGS. 1, 2 and 3 illustrate such a feature. For each of these figures, the turbine blades 101 are coupled to a generator or alternator 102 via a turbine shaft 103. The generator housing 104 is coupled to a tower (not shown) via a vertically-oriented pivot 105 that is laterally offset from the turbine axis 106. The tail vane 107 is hingeably mounted to the generator housing 104. It is spring or gravity-biased toward a position where it is inline with the turbine axis 106. The mechanism responsible for the furling action is an increase in rotor thrust when the winds and output power are increased. As the thrust force is laterally offset about the tower center, or yaw, axis, the rotor thrust force will generate a yawing moment about the tower. Without the furling feature, the tail vane 107 of the turbine would fight the yawing moment in order to keep the turbine facing directly into the wind. However, the biased tail vane 107 will deflect from the turbine axis 106 when wind speed begins to approach a structurally dangerous level, thereby rotating the turbine axis to a position that oblique to the incoming wind vector 108. The more the turbine axis is turned away from the wind vector, the less coupling efficiency between the wind and the turbine. At a position where the turbine axis is about perpendicular to the wind vector, coupling efficiency drops to near zero.

The spring or gravity biased furling tail vane 107 is designed to maintain the tail perpendicular to the rotor plane in light winds, while allowing the tail vane to furl as the yawing moment increases. FIG. 1 is representative of a light wind condition, where the tail vane 107 is parallel to the turbine axis 106. In this condition, the turbine blades 101 face directly into the wind (i.e., perpendicular to the wind vector 108). FIG. 2 is representative of a moderate wind condition, where the tail vane is partially furled. The furling action causes the turbine to turn partially away from the wind, thereby preventing the turbine from reaching structurally damaging rotational speeds. FIG. 3 is representative of heavy wind conditions that are capable of inflicting almost instantaneous structural damage on the turbine. In high winds, the tail vane furls completely, thereby placing the turbine blades nearly parallel to the wind vector. Thus, for prior art wind turbines, the furling feature is entirely passive and continuous.

Furling acts as both as a power regulator in moderate and high winds and load relief in high winds. This results in a less-than-ideal compromise between power production and surviveability.

### SUMMARY OF THE INVENTION

A wind turbine constructed in accordance with the present invention will preferably use stall control of the rotor to allow the turbine to be oriented into the prevailing wind at all times (resulting in higher operating efficiencies) unless a fault occurs or dangerously high winds occur. In those two conditions, the furling mechanism will be used as an aerodynamic brake.

A latching mechanism is employed in a furling wind tubine to keep the rotor from furling during normal operation, but releasing the tail from the rotor assembly so that the rotor can furl completein the event of a fault condition. A fault condition may occur when the electrical power grid, to which the wind turbine is connected, fails, when the alternator armature winding develops an open circuit and causes an unloading of the turbine, or when the gearbox breaks, also causing an unloading of the turbine.

For a preferred embodiment of the invention, the furling wind turbine is mounted on a generally vertical tower mast having a generally vertical first axis. A main frame is pivotally mounted to the tower mast, being rotatable about the first axis. A rotor shaft, having first and second ends and rotatable about a generally horizontal third axis, is mounted to the main frame. A rotor having at least two blades affixed to the first end of the rotor shaft. An alternator is coupled to the second end of said rotor shaft, either directly, or through a speed-increasing gearbox, which is mounted to the main frame. The alternator may be of the variable-speed, permanent magnet type, or it may be an induction device which may function as both a generator or as a motor to bring the rotor up to optimum generating speed. A tail boom having first and second ends, has its first end pivotally mounted to the main frame on a third axis. For a preferred embodiment of the invention, the first and third axes are coincident, so that the tail boom rotates about the tower mast. A tail affixed to the second end of the tail boom exerts an aerodynamic force during fault-free conditions, which maintains the rotor pointed, at least partially, into a prevailing wind. An aerodynamic force release mechanism maintains the aerodynamic force during fault-free conditions, but releases the aerodynamic force when a fault condition occurs. For a preferred embodiment of the invention, the aerodynamic force release mechanism employs an electromagnet, which when energized, maintains the tail boom locked in place and the tail in the proper position to maintain the aerodynamic force. When power to the electromagnet is cut, the aerodynamic force is released so that the rotor can rotate out of the prevailing wind. The electromagnet may be actively or passively controlled. Using active control sensing, the rotor speed is sensed either directly or indirectly by, for example, measuring the current generated. If the sensed value exceeds a set value, the electromagnet is released, thereby allowing the rotor to move until it is oblique to the direction of the wind. Using passive control, the electromagnet is released under the action of rotor aerodynamic forces or moments.

As additional protection against rotor over-speed conditions, the wind turbine is equipped with an electrically released mechanical brake and a back-up centrifugal brake, which may be either coupled directly to the rotor shaft or to the gearbox output shaft. The centrifugal brake will function in the event of the mechanical brake's failure. The former arrangement has the advantage that, in the event of gearbox failure, the brake can still be used to slow the rotor. The disadvantage of such an arrangement is that the centrifugal brake must be much larger than a centrifugal brake that would be required to stop the rotor on the output side of the gearbox. Both centrifugal brakes and electrically-released mechanical brakes are well known in the art and in the patent literature.

As an option, the tail may be hingeably coupled to the second end of the tail boom about a generally vertical fourth axis. The tail may be spring or gravity loaded so that, as wind speed increases, the rotor is caused to partially furl. Release of the tail boom would then occur only in the event of a fault condition or extremely high wind gusts.

### BRIEF DESCRIPTION OF THE DRAWINGS

FIG. 1 is an isometric view of a prior-art furling wind turbine;

FIG. 2 is a top plan view of a prior-art variable-speed furling wind turbine in light wind conditions;

FIG. 3 is a top plan view of a prior-art variable-speed furling wind turbine in moderate wind conditions;

FIG. 4 is a top plan view of a prior-art variable-speed furling wind turbine in heavy wind conditions;

FIG. 5 is a top plan view of a wind turbine, furlable about a vertical axis and having a latchable tail vane pivotable about a vertical axis, in a latched state in light winds;

FIG. 6 is a top plan view of a wind turbine, furlable about a vertical axis and having a latchable tail vane pivotable about a vertical axis, in a latched state in moderate winds; and

FIG. 7 is a top plan view of a wind turbine, furlable about a vertical axis and having a latchable tail vane pivotable about a vertical axis, in an unlatched state as a result of heavy winds or a grid fault condition.

FIG. 8 is a side elevational view of wind turbine, furlable about a vertical axis and having a latchable tail vane pivotable about a horizontal axis, in a latched state;

FIG. 9 is a side elevational view of a wind turbine furlable about a horizontal axis and having a latchable tail vane that is horizontal during fault-free conditions and pivotable about a horizontal axis, in a latched state.

### DETAILED DESCRIPTION OF THE PREFERRED EMBODIMENTS

A latching mechanism is employed in a furling wind turbine to keep the tail from furling during normal operation, but allowing the tail to release as a means of rotor aerodynamic braking. The latch may be actively or passively controlled. Using active control sensing, the rotor speed is sensed either directly or indirectly by, for example, measuring the current generated. If the sensed value exceeds a set value, the latch is disengaged, allowing the tail to furl and moving the rotor oblique to the direction of the wind. Using passive control, the latch disengages under the action of rotor aerodynamic forces or moments.

For active furling control, the tail may be latched with an electromagnet. When rotor speed reaches a set value that equates a safe operational limit, the electromagnet is released. In addition, a fault condition will automatically release the electromagnet. Active furling control may also be implemented using a stepper motor to optimize the furling angle. Alternatively, active furling control may be implemented using a disk brake having a signal actuated caliper or clutch that is released under conditions nearing those where the structural integrity of the turbine would be compromised.

For passive furling control, the tail may be latched with a permanent magnet, or with a spring-loaded ball latch. Using the former technique, the furling point is determined by the strength of the magnet; using the latter, the furling point is determined by the force exerted by the compressed spring.

Restoration of the latched condition may be accomplished using a variety of techniques. An electromagnet can be coupled to a short clevis that pivots with the tail and pulls the tail back to the latched position when the electromagnet is activated. The tail can also be gravity biased to return to the latched position by using a ramped hinge or a hinge offset from vertical. A spring loaded hinge may also be used to reset the tail to the latched position. In any case, a return to the latched position will only occur in light winds. If no restoration moment is provided, the furled tail may be reset manually. A stepper motor may also be used to reset the furled tail to the latched position. Magnetic repulsion is also another technique that may be used to reset the furled tail. Two -N or two S-S magnets, one of them being an electromagnet, may be used. A pneumatic ram actuated by air pressure from a storage tank may also be used to reset the furled tail.

In order to furl a wind turbine having a latched tail, enough lateral offset is provided so that if the latching mechanism is released, the turbine will naturally rotate, or yaw, so that the rotor plane of rotation will be parallel to the wind direction. Alternatively, a stepper motor or other comparable actuator may be used to actively adjust the tailvane angle. The tailvane angle is actively controlled using measured power or rotor speed as a sensor input to the actuator controller.

There are two basic applications for a latching mechanism on a furling wind turbine: constant-speed wind turbines having induction generators and variable-speed wind turbines having permanent magnet generators.

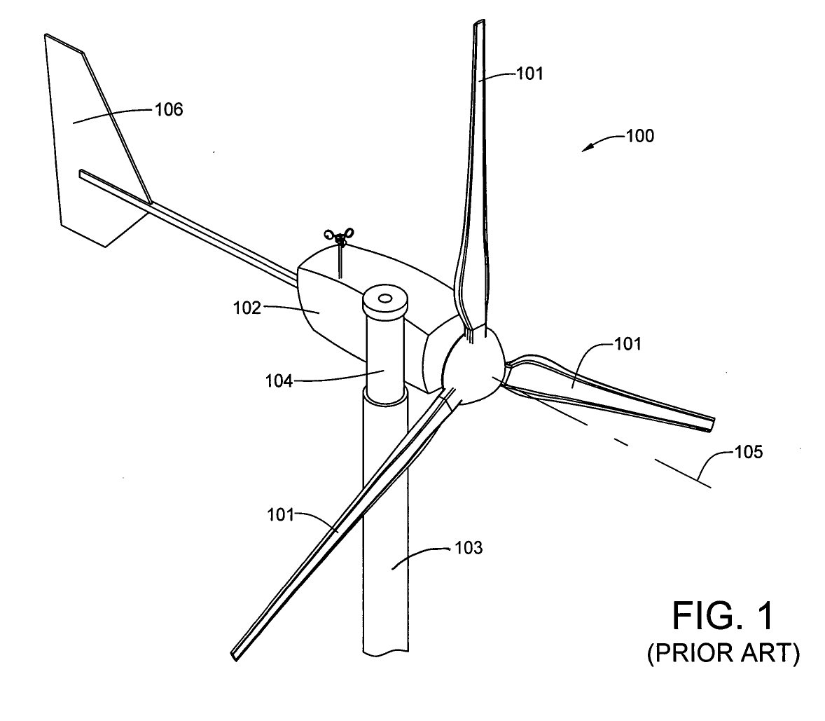

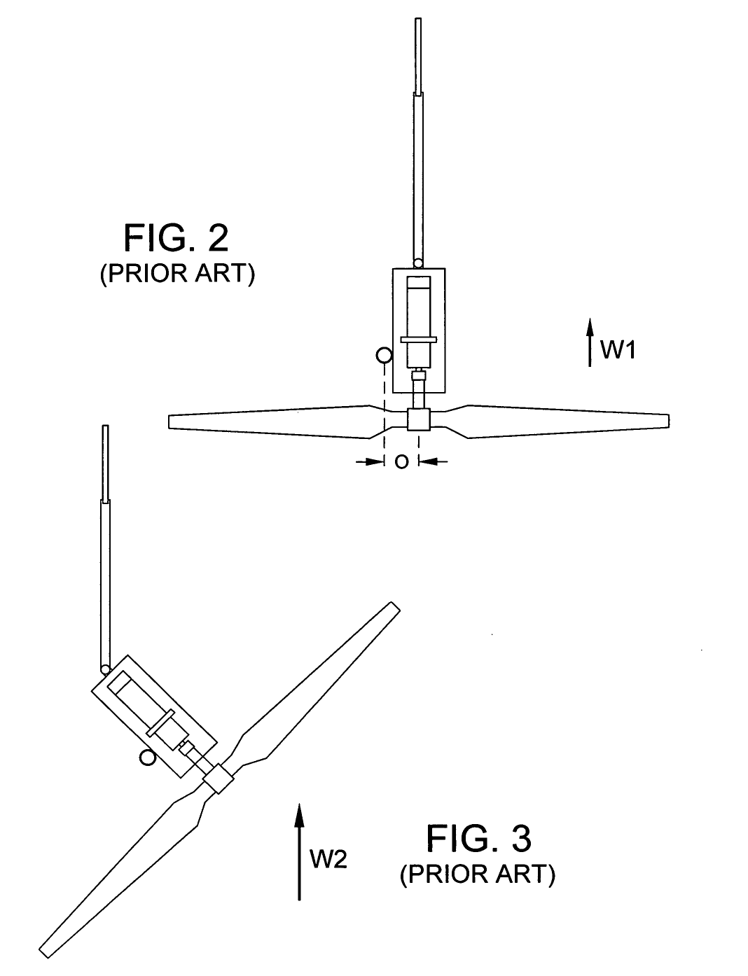

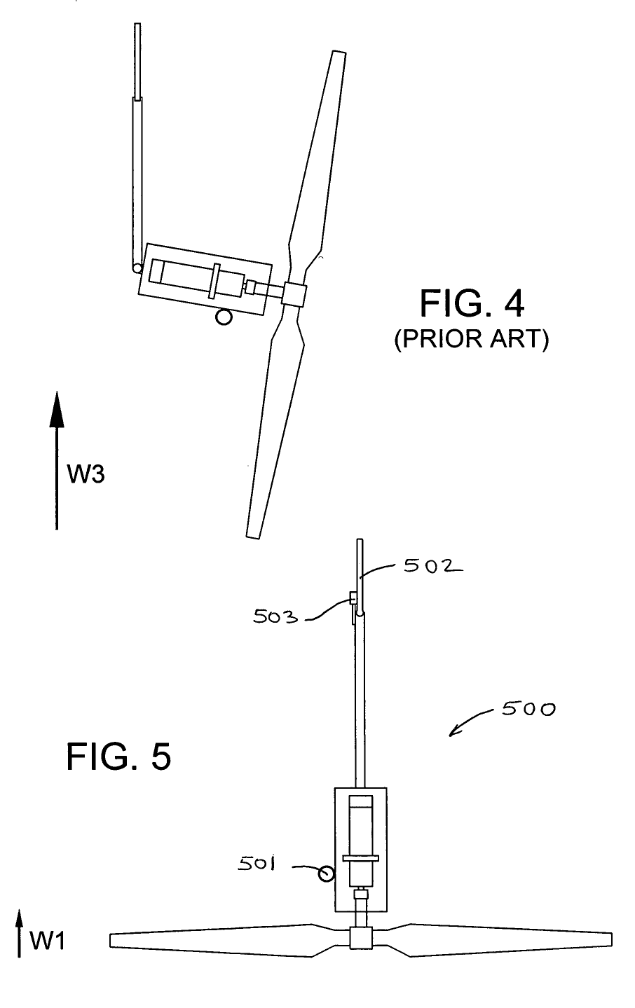

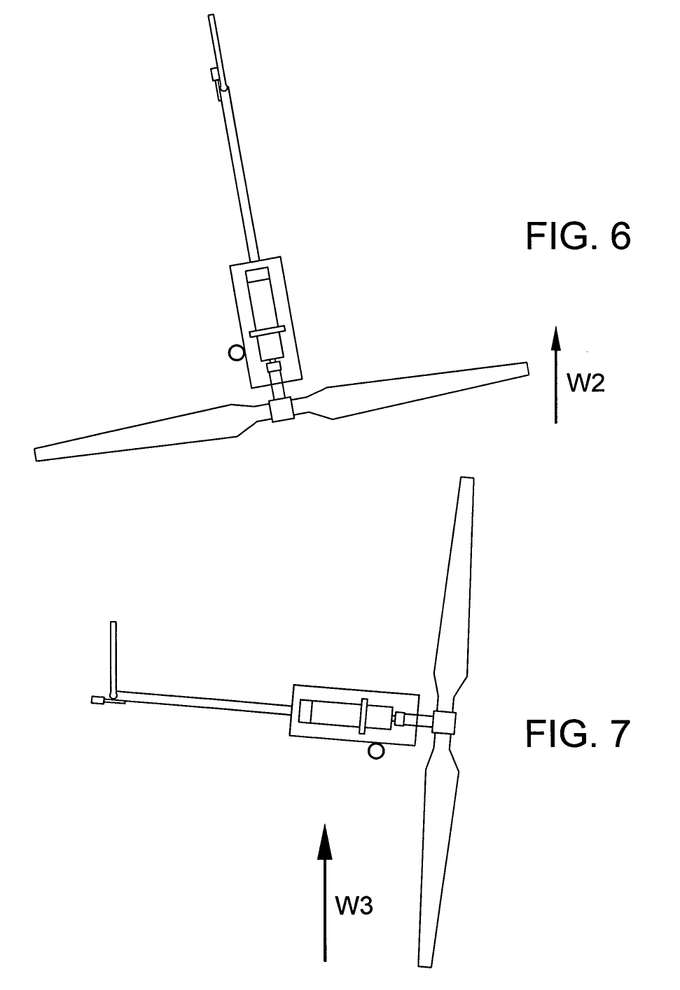

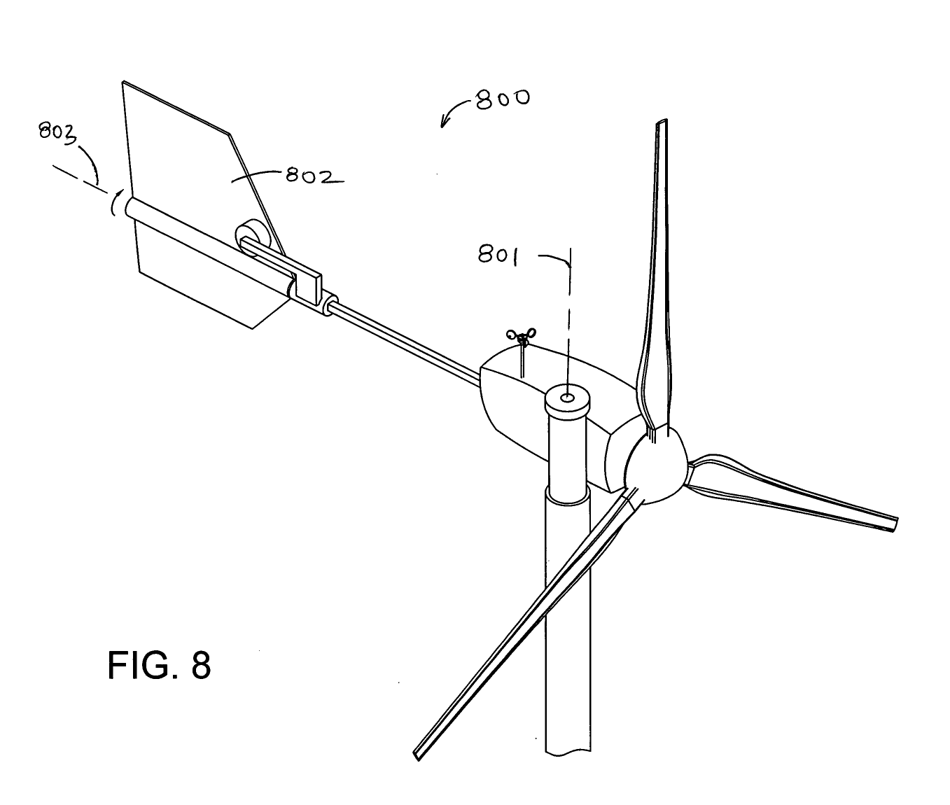

For constant-speed wind turbines having induction generators, the latching mechanism may be used as an aerodynamic brake or as a backup to a mechanical brake. The latch is engaged for normal operation, but released in response to overspeed or electric grid fault conditions. With the tail hinged as shown in FIG. 1, passive furling is employed to assist stall regulation. The tail latch is used as an aerodynamic brake during a fault condition. Where the tailvane angle is actively controlled, as with a stepper motor, for power regulation, the tail latch is used as an aerodynamic brake during a fault condition. In both cases, when the latch releases, the tail is free to rotate.

For variable-speed wind turbines having permanent magnet generators, power electronics may be employed regulate the power generated by vary the loading on the generator. The tail latch may be used as an aerodynamic brake during a fault condition. Alternatively, the tailvane angle may be actively controlled to regulate power or rotor speed, and the tail latch may be used as an aerodynamic brake during a fault condition. Yet another alternative is to use a permanent magnet to hold the tail so that the turbine faces generally into the wind. The strength of the magnet is chosen so that only a large wind gust will unlatch the tail and result in full furling.

The invention also contemplates an embodiment where a tailvane is hinged in a horizontal plane, with the hinge axis parallel to the wind vector. When the tailvane is vertical, the turbine faces directly into the wind. When the plane of the tailvane is horizontal, the turbine will furl out of the wind. In order to facilitate rotation of the tailvane by the wind when the tailvane is unlatched, the hinge is offset from the tailvane's central longitudinal axis.

For vertical furling wind turbines, the tailvane is hinged in a horizontal plan perpendicular to the wind direction. Then the latch is released, the tailvane will catch the wind like a car door with a strong wind coming from behind and furl the turbine.

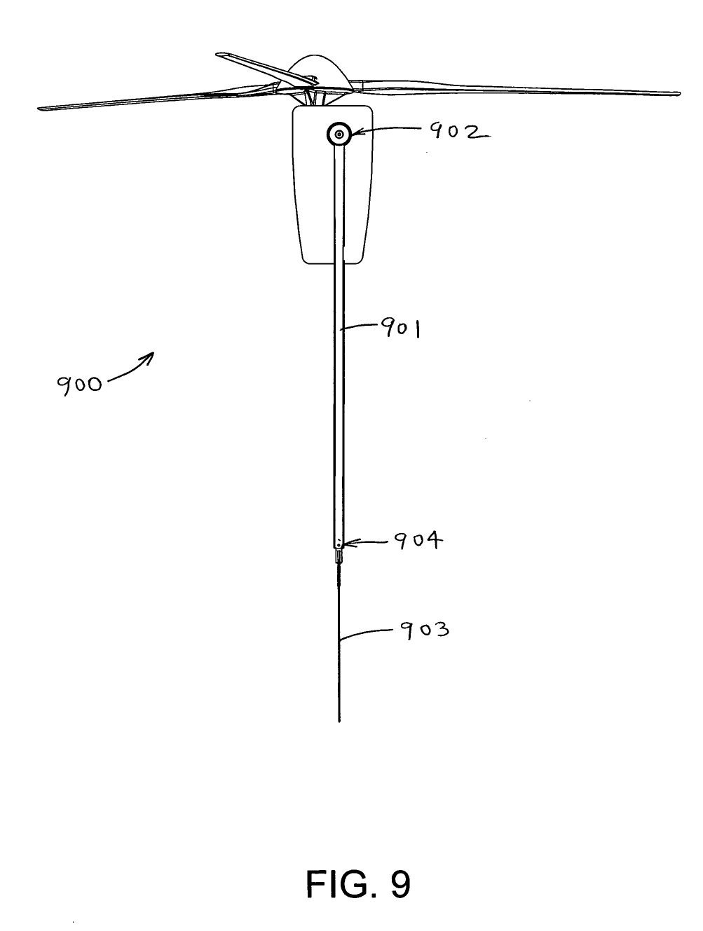

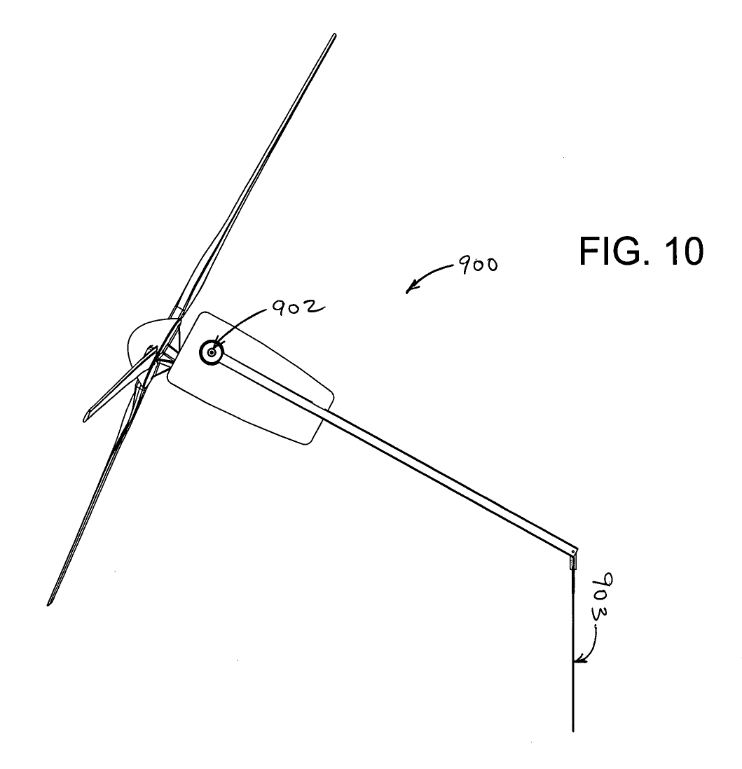

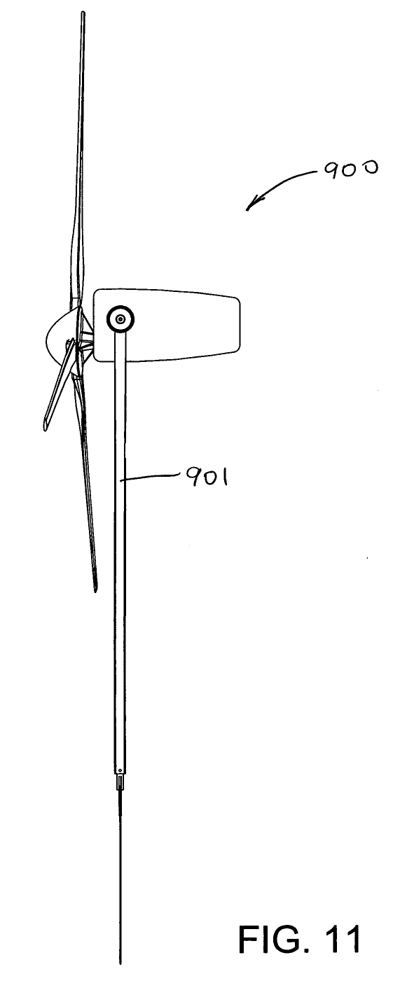

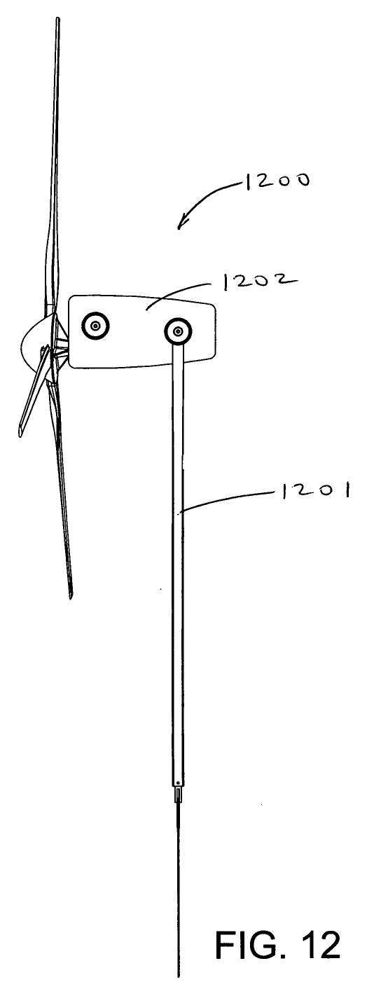

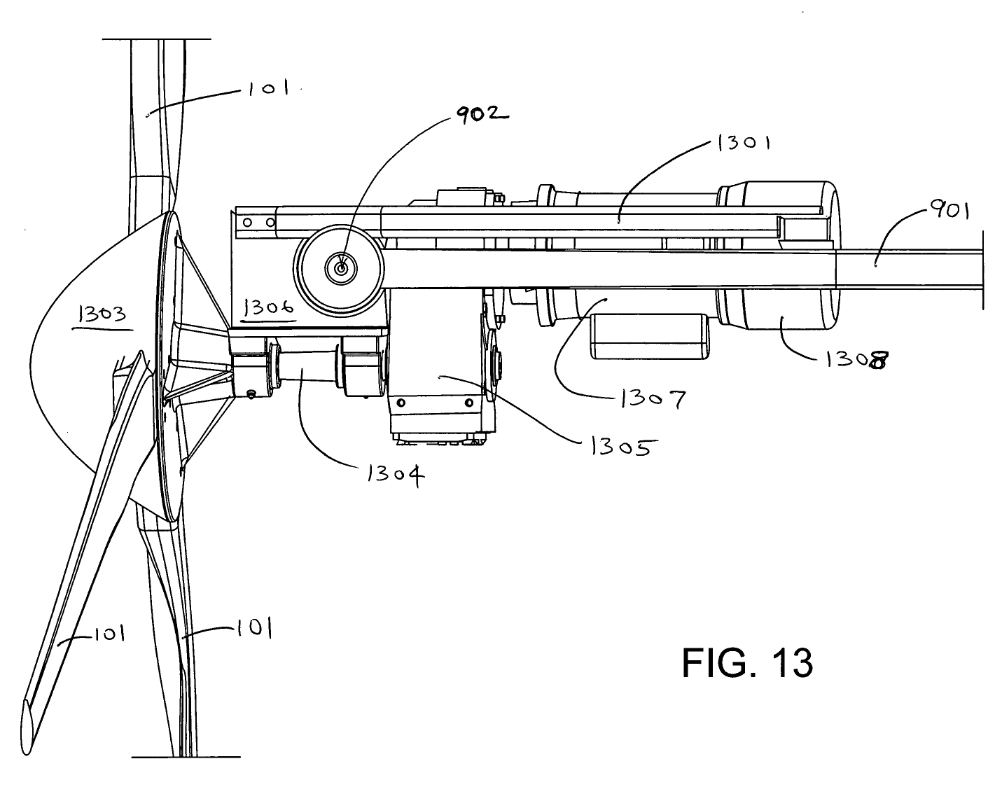

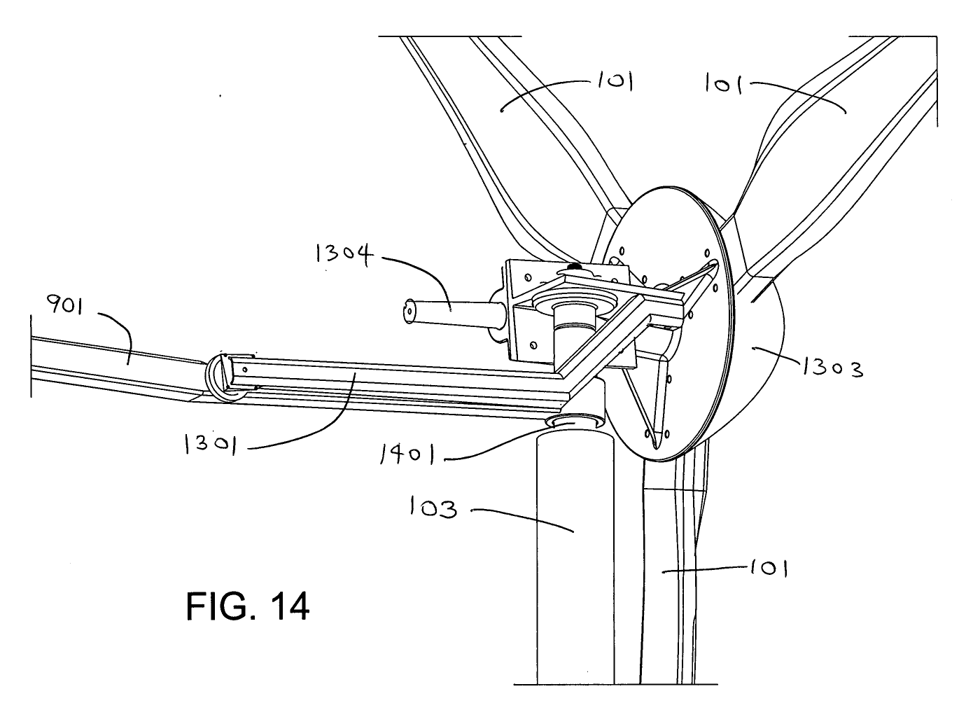

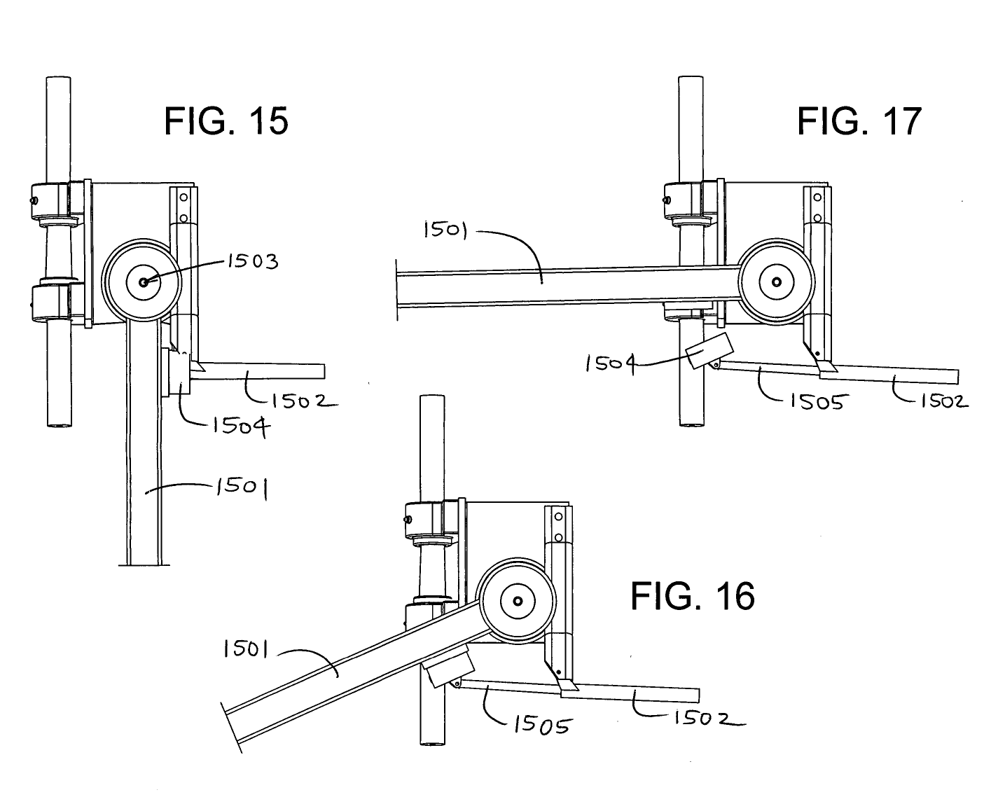

One of the problems encountered with the furling configuration is that structurally-damaging rotor speeds may be reached during the time the turbine rotates from being directly into the prevailing wind to fully furled. There are two ways to deal with the problem. The first is to use a pre-furl (having a furl angle or yaw error before a fault) particularly during high winds, so that the turbine will only have to yaw only 20-30 additional degrees before rotating entirely out of the wind. FIGS. 9, 10 and 11 show how this method functions. In these drawings, it will be noted that the tail boom has been rotatably attached to the tower spindle. Although mostly a mainframe structure consideration, it also helps to get the turbine fully furled after or during a fault. This is because if the tail is attached at the end of the mainframe the drag on the tail, in high winds, will result in an unfurling yaw moment (see FIG. 12).

FIGS. 9, 10 and 11 show the basics of a double hinged tail. The tail is hinged at the tower and held with an electromagnet mounted on a magnet boom that is attached to the mainframe (see FIG. 13). The tail, if released, is restored with a weak spring (not shown). Unless some fault has occurred the tail will be held (by the electromagnet) to the magnet boom. The tailplane is attached to the end of the tailboom with another hinge. The tailplane will be held parallel to the tailboom by some means (a mechanical spring is the currently preferred device). If the winds increase the tail fin will be allowed to rotate (against the spring) and the turbine will be allowed to pre-furl.

Referring now to FIG. 12, if the tail is attached to the back of the mainframe then the tailboom and tailplane drag force will cause an unfurling moment. This could cause large rotor speeds if the rotor is unloaded (i.e. a fault has removed all of the generator load and the mechanical brake is faulty).

Referring now to FIG. 13, the details of the tailboom, the magnet boom and electromagnet that hold the tailboom during normal operation are shown. This figure also shows the rotor's lateral offset from the yawing axis. Referring now to FIG. 14, this view shows the tailboom, and magent boom, as well as how the tailboom is hinged at the tower spindle. The magnet boom is attached to the mainframe. Gearbox, generator, and high speed brake have been removed for clarity.

Referring now to FIGS. 15, 16 and 17, another option is to allow the magnet to move out from the magnet boom. This allows prefurling to occur without the hinged tailplane. In this design the tailplane is rigidly attached at the end of the tailboom. FIG. 15 shows a spring damper near the tower axis centerline. In this configuration one end of the spring damper is attached to the magnet boom and the magnet is attached to the end of the piston. Then the piston is allowed to extract which allows for pre-furl. An internal spring (not shown) is resisting furling and restores the piston if the magnet is released. The damper would preferably be one-way which resists unfurling but moves freely in the furling direction.

A problem with this design is that the magnet has to be larger to hold the furling moment during normal operation since it is located near the yawing axis. However, if the spring damper assembly is moved away from the yawing axis the magnet hold force can be reduced but the cylinder travel increases dramatically. One solution is to use a latch that can be released instead of the electromagnet.

The technique for overspeed control shown in FIG. 15 is applicable for turbines that are variable speed (i.e. permanent magnet alternators) and for turbines that are either stall regulated or passively furled regulated. Although the presently preferred wind turbine is a constant speed induction machine, the other options are to be considered part of this invention.

What is claimed is:

1. A wind turbine comprising:
a tower mast having a first generally vertical axis;
a main frame pivotally mounted to said tower mast and rotatable about said first generally vertical axis;
a rotor shaft mounted to said main frame, said rotor shaft having first and second ends and rotatable about a generally horizontal axis, said horizontal axis being horizontally displaced from said first generally vertical axis;
a rotor having at least two blades affixed to said first end of said rotor shaft;
an alternator coupled to the second end of said rotor shaft;
a tail boom having first and second ends, said first end pivotally mounted to said main frame about a second generally vertical axis; and
a tail affixed to said second end of said tail boom, said tail having a pair of back-to-back, generally parallel, vertical surfaces which in no-wind conditions are generally parallel to said horizontal axis, said tail and tail boom cooperating to maintain said rotor facing, at least partially, into a prevailing wind during fault-free conditions; and
a boom release mechanism that prevents movement of said tail boom about said second generally vertical axis during fault-free conditions, during which conditions, said tail boom and said horizontal axis are maintained generally parallel to one another, said boom release mechanism releasing said tail boom so that said main frame and attached rotor can turn away from the prevailing wind when a fault condition occurs.

2. The wind turbine of claim 1, wherein said first generally vertical axis and said second generally vertical axis are coincident.

3. The wind turbine of claim 1, wherein said alternator is coupled to the second end of said rotor shaft through a gearbox, said gearbox mounted on said mainframe.

4. The wind turbine of claim 1, wherein said alternator is of the permanent magnet genre, and is directly coupled to the second end of said rotor shaft.

5. The wind turbine of claim 1, wherein said tail boom is held immovably affixed to said main frame during no fault conditions by an electromagnet that is energized only during fault-free conditions.

6. The wind turbine of claim 1, which further comprises a centrifugal brake to protect against blade over-speed conditions, said centrifugal brake coupled to and acting directly on said rotor shaft.

7. The wind turbine of claim 3, wherein said gearbox has an output shaft that is coupled to said alternator, and said wind turbine further comprises a centrifugal brake to protect against blade over-speed conditions, said centrifugal brake acting on the gearbox output shaft.

8. The wind turbine of claim 1, wherein said tail is hingeably coupled to said second end about a second generally vertical axis.

9. The wind turbine of claim 8, wherein said tail is spring-biased to a position where said back-to-back, generally parallel, vertical surfaces are generally parallel to said horizontal axis during no-wind conditions.

10. The wind turbine of claim 8, wherein said tail is gravity-biased to a position where said back-to-back, generally parallel, vertical surfaces are generally parallel to said horizontal axis during no-wind conditions.

11. A wind turbine comprising:
a tower mast having a generally vertical first axis;
a main frame pivotally mounted to said tower mast and rotatable about said generally vertical first axis;
a rotor shaft mounted to said main frame, said rotor shaft having first and second ends and rotatable about a generally horizontal second axis;
a rotor having at least two blades affixed to said first end of said rotor shaft;
an alternator coupled to the second end of said rotor shaft;
a tail boom having first and second ends, said first end pivotally mounted to said main frame about a third axis;
a tail affixed to said second end of said tail boom, said tail exerting an aerodynamic force during fault-free conditions to maintain said rotor pointed into a prevailing wind; and
an aerodynamic force release mechanism that maintains said aerodynamic force during fault-free conditions, but releases said aerodynamic force when a fault condition occurs.

12. The wind turbine of claim 11, wherein said main frame has a horizontal fourth axis positioned between said first axis and said rotor, said tail boom is generally vertically positioned, said tail is positioned generally horizontally and parallel to said rotor shaft during fault-free conditions, and said tail is positioned generally horizontally and perpendicular to said rotor shaft soon after a fault condition triggers a release of said aerodynamic force.

13. The wind turbine of claim 12, wherein said second axis is vertically displaced from said fourth axis.

14. The wind turbine of claim 11, wherein said second axis is both horizontal and horizontally displaced from said first axis.

15. The wind turbine of claim 11, wherein the first end of said tail boom is pivotally mounted to said main frame about a third, generally vertical axis

16. The wind turbine of claim 15, wherein said first axis and said third axis are coincident.

17. The wind turbine of claim 11, wherein said alternator is coupled to the second end of said rotor shaft through a gearbox, said gearbox mounted on said mainframe.

18. The wind turbine of claim 11, wherein said alternator is of the permanent magnet genre, and is directly coupled to the second end of said rotor shaft.

19. The wind turbine of claim 11, wherein said tail boom is held immovably affixed to said main frame during no fault conditions by an electromagnet that is energized only during fault-free conditions.

20. The wind turbine of claim 11, which further comprises a centrifugal brake to protect against blade over-speed conditions, said centrifugal brake coupled to and acting directly on said rotor shaft.

21. The wind turbine of claim 18, wherein said gearbox has an output shaft that is coupled to said alternator, and said wind turbine further comprises a centrifugal brake to protect against blade over-speed conditions, said centrifugal brake acting on the gearbox output shaft.

22. The wind turbine of claim 11, wherein said tail is hingeably coupled to said second end about a second generally vertical axis.

23. The wind turbine of claim 22, wherein said tail is spring-biased to a position where said back-to-back, generally parallel, vertical surfaces are generally parallel to said horizontal axis during no-wind conditions.

24. The wind turbine of claim 22, wherein said tail is gravity-biased to a position where said back-to-back, generally parallel, vertical surfaces are generally parallel to said horizontal axis during no-wind conditions.
